(19) United States
(12) Patent Application Publication
(10) Pub. No.: US 2002/0043925 A1
(43) Pub. Date: Apr. 18, 2002

(54) Thin-film electroluminescent phosphor

(76) Inventors: Sey-Shing Sun, Beaverton, OR (US); Tom Jones, Middletown, NJ (US)

Correspondence Address: Kevin L. Russell, Suite 1600, 601 SW Second Ave., Portland, OR, 97204-3157, US

(21) Appl. No.: 09/810,321

(22) Filed: Mar. 15, 2001

Related U.S. Application Data
(62) Division of application No. 09/649,153, filed on Aug. 28, 2000.
(60) Provisional application No. 60/190,122, filed on Mar. 16, 2000.

(51) Int. Cl. H01J 1/62; H01J 63/04

(52) U.S. Cl. 313/502; 313/504

(57) ABSTRACT

A light emitting phosphor material for an alternating current thin-film electroluminescent (ACTFEL) device and/or an ACTFEL device includes the phosphor material sandwiched between a pair of dielectric layers suitable to substantially prevent DC current from flowing therebetween. The phosphor material is comprised of, in one aspect of the present invention, the formula M^{II}S:Eu,Cu, wherein M^{II} is strontium, S is sulphur, Eu is europium, Cu is copper. In another aspect of the present invention, the phosphor material is comprised of the formula M^{II}S:Eu,Cu, wherein M^{II} is calcium, S is sulphur, Eu is europium, Cu is copper. In yet another aspect of the present invention, the phosphor material is comprised of the formula M^{II}S:Eu,Cu, wherein M^{II} is strontium and calcium, S is sulphur, Eu is europium, Cu is copper. In a further aspect of the present invention, the phosphor material is comprised of the formula M^{II}S:Mn,Cu, wherein M^{II} is strontium, S is sulphur, Mn is manganese, Cu is copper. In a further aspect of the present invention, the phosphor material is comprised of the formula M^{II}S:Mn,Cu, wherein M^{II} is calcium, S is sulphur, Mn is manganese, Cu is copper.

### BACKGROUND OF THE INVENTION

The following application relates to thin film electroluminescent phosphor material, and in particular to alkaline earth sulfide thin films with multiple coactivator dopants.

Powder rare earth doped alkaline earth sulfides such as strontium sulfide (SrS:Eu) and calcium sulfide (CaS:Eu) have been investigated as red emitters for cathode ray tube (CRT) displays by W. Lehmann et al., Cathodoluminescence of Cas:Ce³⁺ and CaS:Eu²⁺ Phosphors, Luminescence of Solid Solutions, Vol. 118, No. 3, March 1971. W. Lehmann et al. determined that the Eu emission efficiency may be improved by incorporating a small amount of Ce as a co-dopant. This Eu emission efficiency is due to significant overlap between the emission spectra of Ce ions and the absorption spectra of Eu ions and consequently an effective non-radiative energy transfer from excited Ce ions to Eu ions (sensitization) is performed.

Higton et al., U.S. Pat. No. 4,365,184, disclose what is generally known in the art as a DC powder electroluminescent device. The construction of a powder electroluminescent device includes a pair of electrodes 14 and 18 with a phosphor layer 12 inderdisposed therebetween. The phosphor layer 12 is a thick film, generally having a thickness of 25 microns or more, which is normally applied in a manner similar to “paste.” Powder electroluminescent devices are illuminated using a DC current, such as: 3 mA at 100 volts (example 1); 6 mA at 100 volts (example 2); 5 mA at 100 volts (example 5); 5 mA at 110 volts (example 6); and 5 mA at 100 volts (example 7). The use of a DC current between the electrodes is necessary because the powder phosphor layer, as taught in Higton et al., is a semi-insulating material and a large net DC current flow is required for illumination. The core of each phosphor particle is coated, or otherwise formed, with a resistive layer of material, such as CuS, thereon. The resistive layer injects carriers into the powder at a much lower average electric field strength than tunneling fields required for the operation of ACTFEL devices, described below. This resistive current then excites the activator atoms in the powder phosphor to emit light. Unfortunately, the characteristics of the resistive layer changes during extended usage which raises its threshold voltage. The increase in the threshold voltage thereby decreases the brightness of the display. If the resistive layer surrounding the particles were removed then the phosphor layer would act as a “short circuit” rendering the device ineffective. Higton et al. disclose a DC powder device where the use of an AC signal would not impose a sufficient voltage on the particles for illumination. Further, if an AC voltage was applied to the powder electroluminescent device disclosed by Higton et al. the efficiency of the device would be extremely low because of the resistance layer.

In contrast to the powder electroluminescent device of Higton et al. an alternating current thin-film electroluminescent device includes a phosphor layer sandwiched between a pair (or at least one) of dielectric layers suitable to substantially prevent DC current from flowing therebetween. The resulting capacitive structure allows imposing large AC voltages across the light emitting phosphor material. A thin-film device includes a phosphor material that is generally formed by deposition, such as sputtering, atomic layer epitaxy, evaporation, and has a thickness of generally three microns or less, in comparison to the 25 micron or greater “paste” taught by Higton et al. Thin-film devices have a light emitting mechanism based on a high field tunneling mechanism and the impact excitation of activator atoms, which is different than DC powder devices, as previously discussed. Moreover, alternating current thin-film devices have a phosphor material that includes an organized lattice structure while the phosphor of DC powder devices is similar to a “paste”.

Because of the different operating principals of powder devices and ACTFEL devices, together with different phosphor material characteristics (resistive layer and thickness), one of ordinary skill in the art of developing phosphors for alternating current thin film electroluminescent (ACTFEL) devices would not consider phosphors for thick-film powder devices disclosed by Higton et al. suitable, as described below.

Example 7 of Higton et al. suggests the use of SrS:Tm,Cl,Cu. Based on prior tests, it is known in the field of ACTFEL devices that Tm doping is very inefficient and not suitable for ACTFEL. Further even for powder devices for which the phosphor was designed for, Tm results in a low blue/green luminance, such as 5 foot lamberts in the blue/green region of the spectrum. The reason for low luminance in ACTFEL devices is that there are two possible transitions that produce light using Tm, namely, one transition that results in some blue/green light occurring approximately 10 percent of the time, and another transition resulting in infra-red light occurring approximately 90 percent of the time.

Example 1 of Higton et al. suggests the use of a powder SrS:Mn,Cu. Based on prior tests it is known in the field of ACTFEL devices that SrS:Mn phosphor material is not efficient for ACTFEL devices. The theory is that in the organized lattice structure of ACTFEL devices, as opposed to powder phosphors which are generally a “paste,” the Mn is a small ion in comparison to Sr and thus the Mn does not fit well within the organized Sr matrix that results from deposited ACTFEL structures. The resulting poor fit results in structural defects within thin-films. In addition, Mn tends to segregate forming grain boundaries.

Example 3 of Higton et al. suggests the use of CaS:CeCl. Ce is known in the field of ACTFEL devices to be unstable in terms of maintaining brightness performance. The Ce results in a device which primarily emits light in the green region of the spectrum.

Examples 4 and 5 of Higton et al. suggests the use of CaS:Eu and CaS:EuCl which primarily emits light in the red region of the spectrum. In an ACTFEL device, the Eu atom readily switches between the 2+and the 3+states. The 2+state provides red light when it changes state, while the 3+state provides little visible light. Accordingly, using Eu in ACTFEL device is not efficient.

Example 6 suggests the use of SrS:Cu,Na which primarily emits light in the green region. The use of sodium (Na) in ACTFEL devices is undesirable because of its known inefficiencies when applied to ACTFEL devices.

By way of example, Ando et al. in a paper entitled Electro-optical response characteristics of rare-earth-doped alkaline-earth-sulfide electroluminescent devices, J. Appl. Phys. 65 (8), 15 April 1989, disclosed the use of SrS:Eu,Ce and CaS:Eu,Ce co-dopant devices to attempt to increase to the response speed of Eu doped SrS or CaS devices. The EL emission color is red, which is emitted from Eu luminescent centers. Therefore, the energy transfer process exists from Ce to Eu. Ando et al. therefore surmised that co-doping small amounts of Ce to CaS:Eu improves the response characteristics because Ce is excited first. While the luminescence of these devices improved with Ce co-doping, the luminance of SrS:Eu,Ce devices degraded quickly with time, which is an unacceptable for displays. Accordingly, the attempt to use the powder teachings of W. Lehmann (SrS:Eu,Ce) applied to thin film devices (Ando et al.) likewise resulted in unacceptable performance.

By way of example, Tanaka et al., in a paper entitled Stable White SrS:Ce,K,Eu TFEL with Filters for Full-Color Devices, SID 89 Digest, pages 321-324, suggested the use of SrS:Ce,K,Eu as a white light emitting phosphor. Similar to SrS:Eu,Ce, the luminance of SrS:Ce,K,Eu degraded quickly with time. Tanaka et al. notes on page 323, column 1, that the degradation mechanism is unclear. Accordingly, the attempt to use powder teachings applied to thin film devices (Tanaka et al.) likewise resulted in unacceptable performance.

What is desired, therefore, is a red emitting thin film electroluminescent material that has high luminance characteristics combined with minimal aging effects so that the luminance remains high over time.

### SUMMARY OF THE INVENTION

The present invention overcomes the aforementioned drawbacks of the prior art by providing a light emitting phosphor material for an alternating current thin-film electroluminescent (ACTFEL) device and/or an ACTFEL device that includes the phosphor material sandwiched between a pair of dielectric layers suitable to substantially prevent DC current from flowing therebetween. The phosphor material is comprised of, in one aspect of the present invention, the formula M^{II}S:Eu,Cu, wherein M^{II} is strontium, S is sulphur, Eu is europium, Cu is copper. In another aspect of the present invention, the phosphor material is comprised of the formula M^{II}S:Eu,Cu, wherein M^{II} is calcium, S is sulphur, Eu is europium, Cu is copper. In yet another aspect of the present invention, the phosphor material is comprised of the formula M^{II}S:Eu,Cu, wherein M^{II} is strontium and calcium, S is sulphur, Eu is europium, Cu is copper. In a further aspect of the present invention, the phosphor material is comprised of the formula M^{II}S:Mn,Cu, wherein M^{II} is strontium, S is sulphur, Mn is manganese, Cu is copper. In a further aspect of the present invention, the phosphor material is comprised of the formula M^{II}S:Mn,Cu, wherein M^{II} is calcium, S is sulphur, Mn is manganese, Cu is copper.

In another aspect of the present invention, a light emitting phosphor material for an alternating current thin-film electroluminescent device includes phosphor material sandwiched between a pair of dielectric layers suitable to substantially prevent DC current from flowing therebetween. The phosphor material is comprised of the formula M^{II}S:Eu,xx, wherein M^{II} is at least one of strontium and calcium, S is sulphur, Eu is europium, and xx is a co-dopant that results in an insignificant change in the emission spectra of M^{II}S:Eu, wherein M^{II} is the at least one of strontium and calcium, S is sulphur, Bu is europium, while also providing a significant energy transfer from xx centers to Eu centers.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a partial side cutaway view of an ACTFEL device constructed according to the invention.

FIG. 1A is a partial side cutaway view of an alternative embodiment of an ACTFEL device made according to the invention.

FIG. 2 is a graph illustrating the spectral characteristics of Cu co-doped SrS:Eu and Ce co-doped SrS:Eu.

FIG. 3 is a graph illustrating photoluminescent excitation spectra of SrS:Eu,Cu showing the presence of Cu⁺ excitation bands and indicating the energy transfer from Cu⁺ to Eu²⁺ ions.

FIG. 4 is a graph illustrating the aging characteristics of SrS:Eu,Cu and SrS:Eu,Ce.

FIG. 5 is a graph illustrating the luminance of SrS:Eu by co-doping with Cu.

FIG. 6 is a graph illustrating the luminance of SrS:Mn by co-doping with Cu.

FIG. 7 is a graph illustrating the efficiency of SrS:Eu by co-doping with Cu.

FIG. 8 is a photoluminescence excitation spectra of SrS:Eu,Cu and Srs:Mn,Cu.

FIG. 9 is a graph of the chromaticities of singly doped and Cu co-doped SrS:Eu and SrS:Mn systems.

### DETAILED DESCRIPTION OF THE PREFERRED EMBODIMENT

The present inventors came to the realization that poor luminance stability of SrS:Eu,Ce devices in an ACTFEL device (as described in more detail below) is a result of poor stability of Ce emission centers. This poor luminance stability the present inventors surmised is because the enhanced Eu emission is the result of an energy transfer from Ce centers. As the Ce centers age, there is little energy available for exciting Eu centers and the red emission decreases quickly. Accordingly, for Eu doped CaS and SrS to be a suitable ACTFEL phosphor, it is necessary to discover a better (stable) sensitizer than Ce.

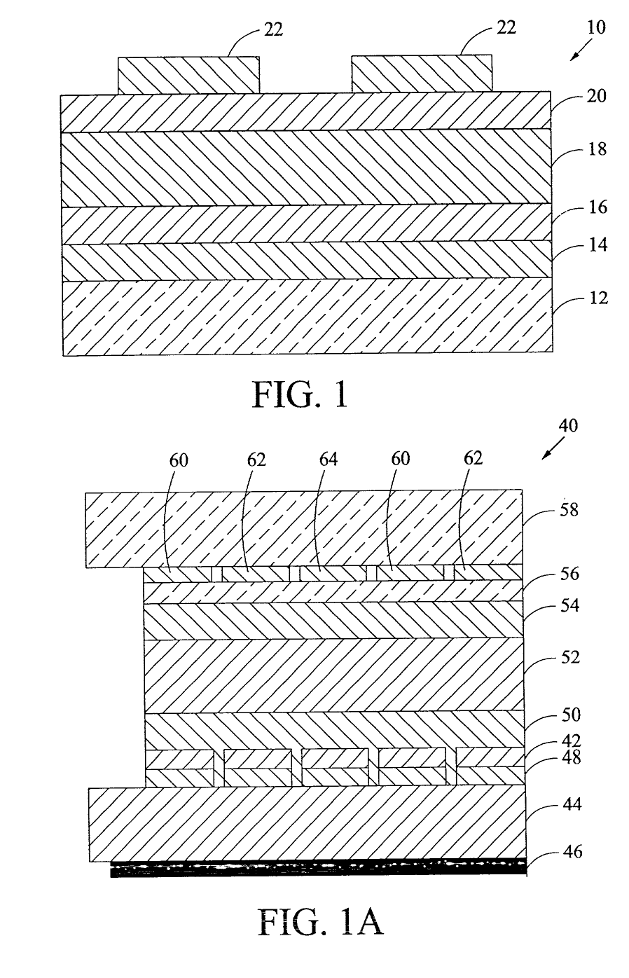

An ACTFEL device 10 as shown in FIG. 1 includes a glass substrate 12 onto which is deposited a layer of indium tin oxide 14. Next an insulator layer 16 comprising an aluminum/titanium oxide is deposited. A phosphor layer 18 comprises a thin film of M^{II}SS:Eu,Cu, such as SrS:Eu,Cu. The phosphor layer 18 is sandwiched by a second insulator 20 preferably made of barium tantalate (BTO). Aluminum electrodes 22 are placed atop the BTO layer 20. The first insulator layer 16 is preferably approximately 260 nanometers thick and is deposited by atomic layer epitaxy (ALE). The electroluminescent phosphor layer 18 is preferably 600 nanometers to 2 micrometers thick and it is preferably deposited by sputtering from an SrS target prepared with the following doping concentration: europium, 0.05 to 5 mol %; copper, 0.05 to 5 mol %. To make a full color panel, a second blue light emitting phosphor layer such as SrS:Cu or SrS:Cu,Ag, or other blue emitting phosphor (not shown in S FIG. 1) together with a third green light emitting phosphor layer such as SrS:Ce, SrS:Mn, or SrS:Cu,Na, or other green emitting phosphor (not shown in FIG. 1A) may be deposited on the layer 18. During deposition, the substrate temperature is held to between 75 degrees and 500 degrees C. The phosphor films are then annealed at 550 degrees to 850 degrees C. in nitrogen. This is followed by the deposition of the second insulator layer 20 which is 300 nanometers of BTO. The top aluminum electrodes 22 complete the device fabrication. Red, blue, and green filters may be interposed between the bottom electrode layer 14 and the viewer (not shown) to provide a filtered full-color TFEL display. In an alternative embodiment, either dielectric layer 16 or 20 could be removed.

FIG. 1A shows an “inverted” structure electroluminescent device 40 that is similar to FIG. 1. The device 40 is constructed with a substrate 44 that preferably has a black coating 46 on the lower side if the substrate 44 is transparent. On the substrate 44 are deposited rear electrodes 48. Between the rear electrodes 48 and the rear dielectric layer 50 is a thin film absorption layer 42. The absorption layer is either constructed of multiple graded thin film layers or is a continuous graded thin film layer made by any appropriate method. An electroluminescent layer 52 which may be a laminated structure including at least one layer having the formula M^{II}S:Eu,Cu is sandwiched between a rear dielectric layer 50 and a front dielectric layer 54. In an alternative embodiment, either dielectric layer 50 or 54 could be removed. A transparent electrode layer 56 is formed on the front dielectric layer 54 and is enclosed by a transparent substrate 58 which includes color filter elements 60, 62 and 64 filtering red, blue and green light, respectively, if desired. To make a full color panel, a second blue light emitting phosphor layer such as SrS:Cu or SrS:Cu,Ag, or other blue emitting phosphor (not shown in FIG. 1A) together with a third green light emitting phosphor layer such as SrS:Ce, SrS:Mn, or SrS:Cu,Na, or other green emitting phosphor (not shown in FIG. 1A) may be deposited on the layer 18.

Several SrS targets with various Eu and Cu concentrations were used to fabricate SrS:Eu,Cu devices and the results are shown in the following table. The table illustrates the luminance and luminous efficiency of SrS:Eu,Cu devices dramatically improved with the addition of Cu. The best luminance and luminous efficiency are achieved with devices fabricated from the target having composition of SrS:Eu (1%), Cu (1%), e.g., L40=90 cd/m2 (brightness at 40 volts above threshold), e40=0.52 lm/W (efficiency at 40 volts above threshold).

| | | | Luminous | | |
|---|---|---|---|---|---|
| Eu conc. | Cu conc. | Luminance | efficiency | | |
| mol % | mol % | (cd/m2) | (lm/W) | CIE x | CIE y |
| 0.2 | 0 | 31 | 0.19 | 0.591 | 0.392 |
| | 0.5 | 41 | 0.25 | 0.600 | 0.397 |
| | 1.0 | 55 | 0.35 | 0.596 | 0.400 |
| | 1.5 | 62 | 0.30 | 0.604 | 0.392 |
| 1.0 | 1.0 | 90 | 0.52 | 0.605 | 0.393 |

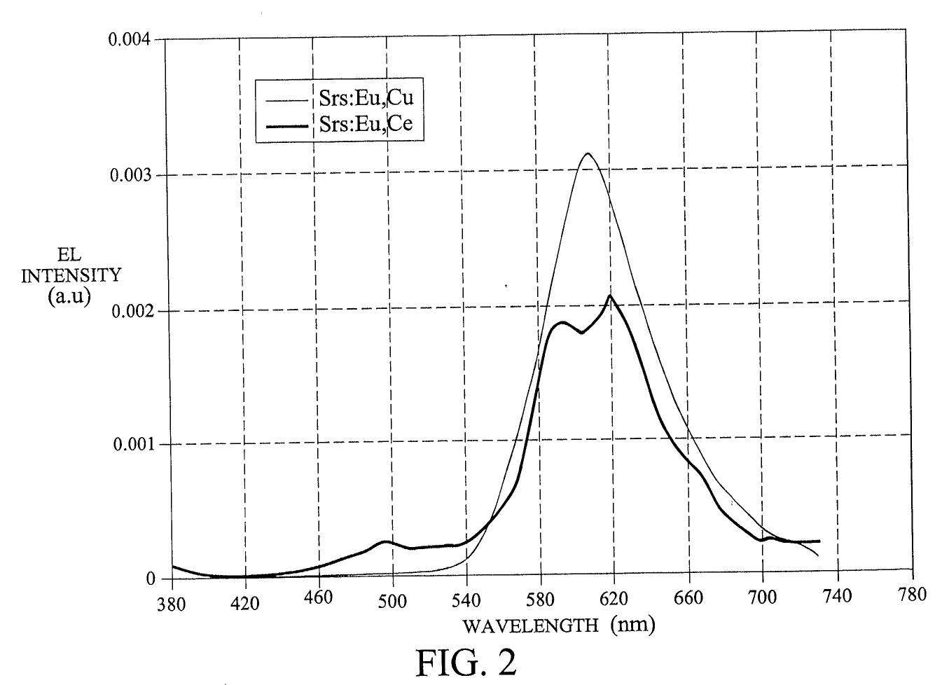

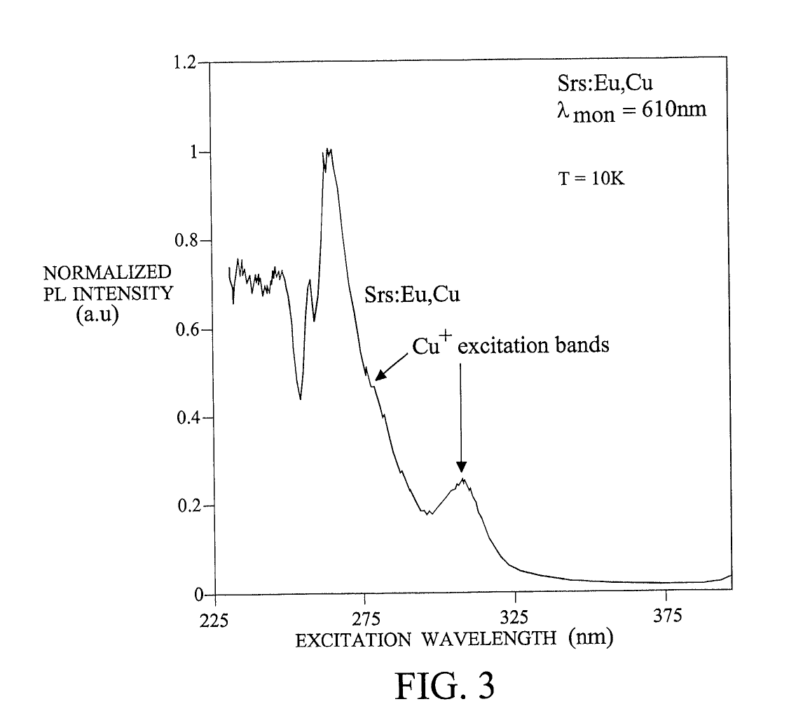

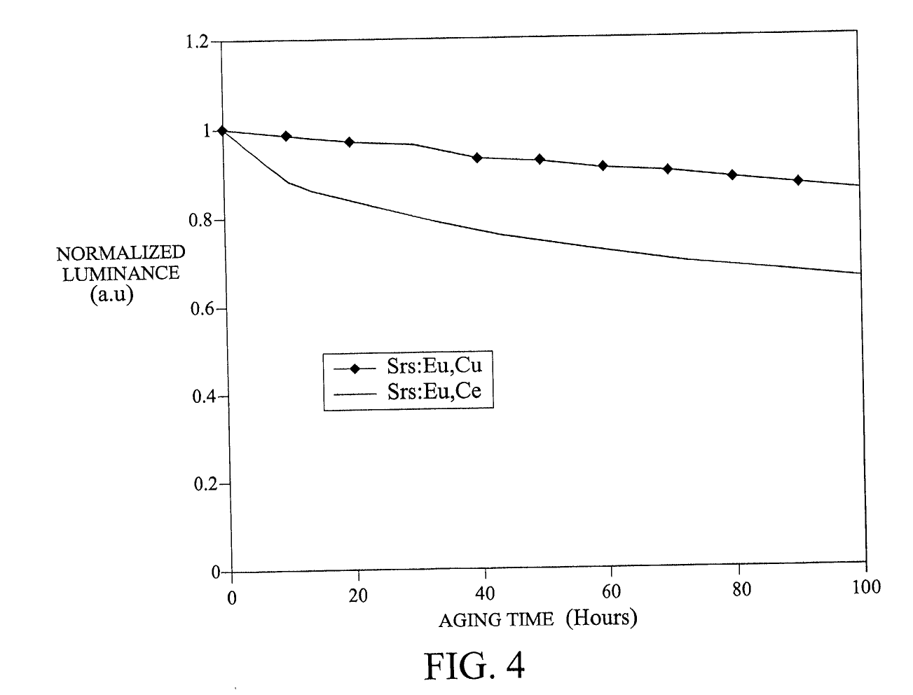

Referring to FIG. 2, to the present inventor's astonishment there is no change (insignificant change) in the emission spectra of SrS:Eu with the Cu co-doping which indicates an effective energy transfer from Cu centers to Eu centers. In contrast, FIG. 2 simultaneously illustrates the significant change in the emission spectra of SrS:Eu with Ce co-doping. This result is confirmed by a photo-luminescent excitation (PLE) study on SrS:Eu,Cu films as shown in FIG. 3, where excitation bands at 238 nm and 310 nm associated with the Cu centers are identified when monitoring Eu emission at 610 nm. The luminance stability of Cu co-doped SrS:Eu is compared with those of Ce co-doped SrS:Eu as shown in FIG. 4. After 100 hours of operation at 1000 Hz and 40 volts above threshold, the Ce co-doped SrS:Eu device lost almost 35% of its original brightness while Cu co-doped SrS:Eu device lost only 15%, which is a significant improvement. The present inventors postulates that this benefit is the result of a more stable Cu center during EL operation. Although not the preferred embodiment, the present inventors has determined that CaS:Eu,Cu likewise provides improved characteristics over CaS:Eu in an alternating current thin-film electroluminescent device, preferably with the same range of concentrations as SrS:Eu,Cu.

A “single-component” phosphor is limited in that the activator must be efficient both in its excitation and radiative properties, severely restricting the number of efficient activators with the desired chromaticities for full color displays. The activator should be chosen such that its exhibits the desired color in the chosen host lattice. In addition, the activator should have a good radiative efficiency to maximize the luminescence.

For the sensitizer, it is necessary to consider the excitation efficiency. The main factors which influence the efficiency are the excitation cross section the sensitizer concentration, the excitation mechanism and the sensitizer lifetime. To maximize the excitation efficiency, the sensitizer must have a large excitation cross section and large doping concentration. The excitation cross section is largely dependent on the excitation mechanism. The impact excitation cross section is small, on the order 10⁻¹⁷−10⁻²⁰ cM², whereas the impact ionization cross section has been shown to be five to ten times larger. Thus, the ionization of Cu⁺ is an important feature leading to a large impact cross section. Another benefit of the sensitizer ionization is that the resulting electron multiplication drastically enhances the quantum efficiency of the phosphor leading to larger luminous efficiencies. The larger impact ionization cross section, enhanced quantum efficiency, and improved injection efficiency are believed to be instrumental for achieving the high efficiencies obtained in the Cu⁺ activated and sensitized systems.

Concentration quenching is a result of non-radiative energy transfer to defects which is governed solely by the activator concentration, independent of sensitizer concentration. Therefore, the sensitizer concentration can be increased to levels much higher than for the activator. Additionally, the radiative lifetime of the sensitizer must be greater than or equal to the radiative lifetime of the activator. Otherwise, even for strongly coupled ions, i.e., the transfer time may be neglected, sensitizer decay is more likely to occur than activator decay resulting in undesired emission characteristics.

The new type of EL phosphor has been coined a “two-component” phosphor. This separation of the excitation and radiative mechanisms gives a greater freedom in choosing materials systems. Of course, the success of this technique hinges on the strength of the energy transfer from the sensitizer to the activator ion. Efficient energy transfer only occurs provided the two ions are strongly coupled through exchange or coulomb interactions. Generally, a large overlap in the emission band of the sensitizer and the absorption band of the activator is also necessary.

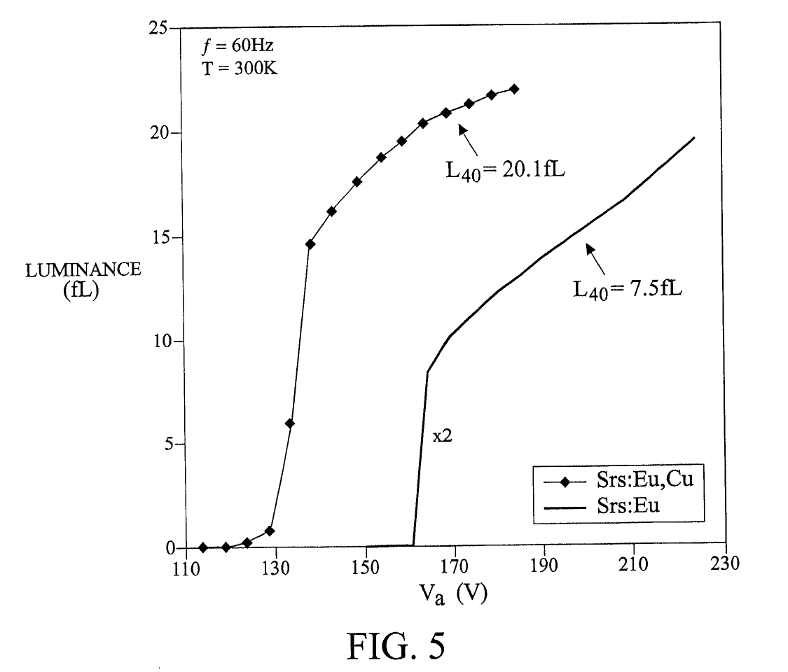

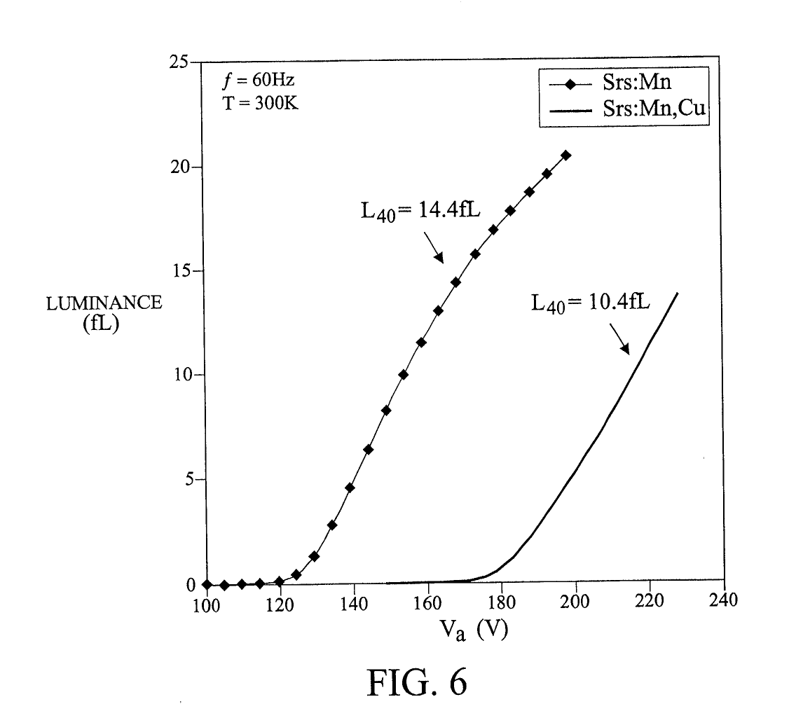

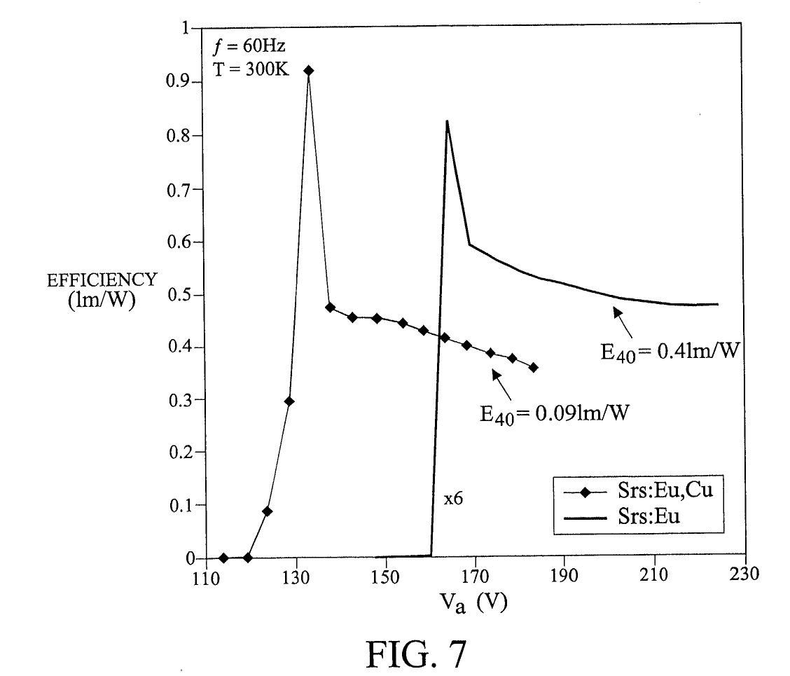

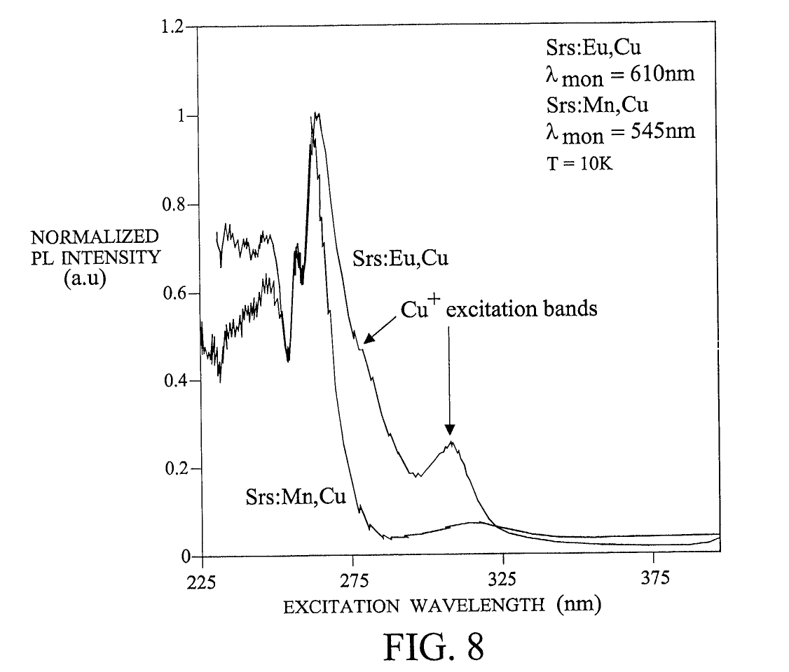

Two new phosphor systems, SrS:Eu,Cu and SrS:Mn,Cu, were created. SrS:Eu is a red emitting phosphor with an emission band centered at 610 nm, while SrS:Mn is green emitting phosphor with an emission band centered at 545 nm. The typical luminance and efficiency for these materials are rather poor, however, as will be discussed, large improvements in the EL performance is attained through Cu co-doping. FIGS. 5 and 6 show the luminance data for the singly doped and co-doped Eu and Mn systems, respectively. Note that in both cases the co-doping improved the EL performance of the phosphor systems. The more dramatic change was seen in SrS:Eu,Cu which exhibited a 3-fold increase in luminance with Cu co-doping. A smaller change was observed in SrS:Mn,Cu where a 38% increase in luminance was obtained. However, the threshold voltage for the co-doped system was drastically lower and was determined to be around 130V. The same was true for the SrS:Eu,Cu system which also exhibited a threshold near 130V. It should be noted that this threshold voltage was roughly the same as for SrS:Cu and SrS:Ag,Cu systems indicating that the electrical properties were determined by the Cu⁺ ion. In addition, the slope of the luminance increase was much larger for the Cu doped system making it more appropriate for display application due to the increase in contrast ratio. Dramatic improvements were also obtained for the EL efficiency in the SrS:Eu,Cu system with less improvements for the SrS:Mn,Cu system. FIG. 7 shows the efficiency as a function of voltage for the singly doped and co-doped Eu system. Note that a 4-fold increase in efficiency was attained in this system. The improvements for both the red and green systems were attributed to energy sensitization within the EL phosphors. This conclusion was supported by PLE measurements on these systems, as shown in FIG. 8. Both SrS:Eu,Cu and SrS:Mn,Cu exhibited the Cu⁺ ion energy level structure showing four excitation bands at 278, 288, 310 and 330 nm when monitoring the respective emission Eu²⁺ and Mn²⁺ bands.

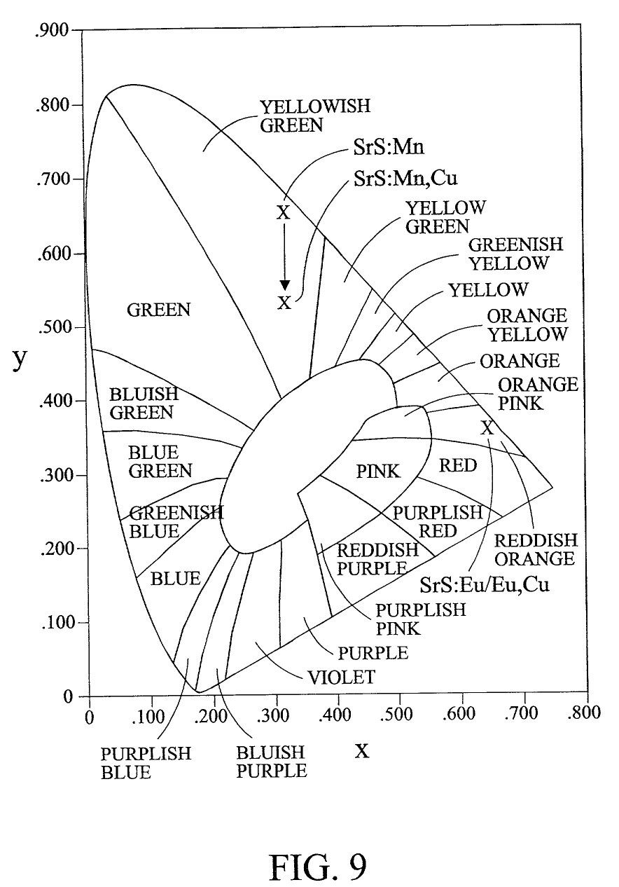

The difference in improvements for the Eu and Mn based systems are explained by the difference in Eu—Cu and Mn—Cu coupling strengths. The Eu²⁺ ion exhibits a parity and spin allowed 4f⁶5d→4f⁷ transition, whereas the Mn²⁺ ion undergoes a parity and spin ⁴T₁→⁶A₁ d-d transition. As a result, the Eu²⁺ transition is very fast (˜400 ns), whereas the Mn²⁺ transition is slower (1.77 ms). The radiative lifetime of the Cu⁺ ion is around 100 μs. Therefore, according to the criteria set forth above, it is expected that the Eu—Cu coping will be stronger than the Mn—Cu coupling since the Cu⁺ is more likely to decay radiatively than to give up its energy to a slow Mn²⁺ ion. In addition, the Eu²+ion has a very broad direct absorption band centered at 450 nm with a long tail that extends into the green region of the spectrum, whereas the Mn²⁺ ion, has a more narrow absorption band centered around 500 nm. Thus, the overlap integral between the Eu absorption band and the Cu⁺ emission band is expected to be much larger than that in the SrS:Mn,Cu system. These factors are realized in the EL emission spectra for the two phosphor systems. The SrS:Eu,Cu exhibited an emission spectrum that was nearly identical to the singly doped Eu system. On the other hand, the SrS:Mn,Cu system showed a small Cu emission band centered near 480 nm in addition to the large Mn emission band at 545 nm. This produced a slight change in the chromaticity for the SrS:Mn,Cu system, whereas no change was observed in the SrS:Eu,Cu system. This situation is illustrated in FIG. 9. Nevertheless, improvements were obtained for both the red and green phosphor systems proving the viability of the two-component phosphor concept. It is to be noted that CaS:Mn,Cu may likewise be used, if desired. The same concentrations are likewise applicable to Mn based phosphors.

SrS:Eu and SrS:Eu,Cu illuminate at about 610 nm which is within the red region but if the principal illumination band could be shifted to a slightly higher wavelength the color gamut of the resulting multi-color phosphor could be increased in addition to having a brighter red. After further consideration the present inventors observed that CaS:Eu illuminates at about 640 nm which is nearly infrared and not highly visible to the human eye. The present inventors came to the realization that if a mixed host of SrS+CaS:Eu is used, and preferably a mixed host of (SrS+CaS):Eu,Cu is used for the increased brightness and improved aging characteristics, then the resulting principal wavelength should be about 625 nm which is a deeper red while retaining high visibility to the human eye. This results in a larger color gamut for a full color display and a “better” red light emitting phosphor.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

1. A light emitting phosphor material for an alternating current thin-film electroluminescent device that includes said phosphor material sandwiched between a pair of dielectric layers suitable to substantially prevent DC current from flowing-therebetween, wherein said phosphor material is comprised of the formula M^{II}S:Eu,Cu, wherein M^{II} is strontium, S is sulphur, Eu is europium, Cu is copper.

2. The phosphor material of claim 1 wherein said light is primarily emitted in the red region of the spectrum.

3. The phosphor material of claim 1 wherein the doping concentration of copper is between 0.05 and 5 mol.

4. The phosphor material of claim 1 wherein the doping concentration of europium is between 0.05 and 5 mol.

5. The phosphor material of claim 1 wherein the doping concentration of europium is between 0.05 and 5 mol and the doping concentration of copper is between 0.05 and 5 mol.

6. The light emitting phosphor material of claim 1 wherein said material is a thin film which has been annealed at between 550-850 degrees C.

7. The light emitting phosphor of claim 1 wherein said phosphor material emits red light, and whose emission spectrum has a peak wavelength between 530 and 700 nm.

8. An alternating current thin-film electroluminescent device comprising front and rear sets of electrodes sandwiching a pair of insulators, said pair of insulators sandwiching thin film electroluminescent phosphor material therebetween suitable to substantially prevent DC current from flowing therebetween, said phosphor material comprising a thin film layer having the formula M^{II}S:Eu,Cu, wherein M^{II} is strontium, S is sulphur, Eu is europium, Cu is copper.

9. The phosphor material of claim 8 wherein said light is primarily emitted in the red region of the spectrum.

10. The phosphor material of claim 8 wherein the doping concentration of copper is between 0.05 and 5 mol.

11. The phosphor material of claim 8 wherein the doping concentration of europium is between 0.05 and 5 mol.

12. The phosphor material of claim 8 wherein the doping concentration of europium is between 0.05 and 5 mol and the doping concentration of copper is between 0.05 and 5 mol.

13. The light emitting phosphor material of claim 8 wherein said material is a thin film which has been annealed at between 550-850° C.

14. The light emitting phosphor of claim 8 wherein said phosphor material emits red light, and whose emission spectrum has a peak wavelength between 530 and 800 nm.

15. A light emitting phosphor material for an alternating current thin-film electroluminescent device that includes said phosphor material sandwiched between a pair of dielectric layers suitable to substantially prevent DC current from flowing therebetween, wherein said phosphor material is comprised of the formula M^{II}S:Eu,Cu, wherein M^{II} is calcium, S is sulphur, Eu is europium, Cu is copper.

16. The phosphor material of claim 15 wherein said light is primarily emitted in the red region of the spectrum.

17. The phosphor material of claim 15 wherein the doping concentration of copper is between 0.05 and 5 mol.

18. The phosphor material of claim 15 wherein the doping concentration of europium is between 0.05 and 5 mol.

19. The phosphor material of claim 15 wherein the doping concentration of europium is between 0.05 and 5 mol and the doping concentration of copper is between 0.05 and 5 mol.

20. The light emitting phosphor material of claim 15 wherein said material is a thin film which has been annealed at between 550-850° C.

21. The light emitting phosphor of claim 15 wherein said phosphor material emits red light, and whose emission spectrum has a peak wavelength between 530 and 700 nm.

22. An alternating current thin-film electroluminescent device comprising front and rear sets of electrodes sandwiching a pair of insulators, said pair of insulators sandwiching thin film electroluminescent phosphor material therebetween suitable to substantially prevent DC current from flowing therebetween, said phosphor material comprising a thin film layer having the formula M^{II}S:Eu,Cu, wherein M^{II} is calcium, S is sulphur, Eu is europium, Cu is copper.

23. The phosphor material of claim 22 wherein said light is primarily emitted in the red region of the spectrum.

24. The phosphor material of claim 22 wherein the doping concentration of copper is between 0.05 and 5 mol.

25. The phosphor material of claim 22 wherein the doping concentration of europium is between 0.05 and 5 mol.

26. The phosphor material of claim 22 wherein the doping concentration of europium is between 0.05 and 5 mol and the doping concentration of copper is between 0.05 and 5 mol.

27. The light emitting phosphor material of claim 22 wherein said material is a thin film which has been annealed at between 550-850° C.

28. The light emitting phosphor of claim 22 wherein said phosphor material emits red light, and whose emission spectrum has a peak wavelength between 530 and 800 nm.

29. A light emitting phosphor material for an alternating current thin-film electroluminescent device that includes said phosphor material sandwiched between a pair of dielectric layers suitable to substantially prevent DC current from flowing therebetween, wherein said phosphor material is comprised of the formula M^{II}S:Eu,Cu, wherein M^{II} ccmprises strontium and calcium, S is sulphur, Eu is europium, Cu is copper.

30. The phosphor material of claim 29 wherein said light is primarily emitted in the red region of the spectrum.

31. The phosphor material of claim 29 wherein the doping concentration of copper is between 0.05 and 5 mol.

32. The phosphor material of claim 29 wherein the doping concentration of europium is between 0.05 and 5 mol.

33. The phosphor material of claim 29 wherein the doping concentration of europium is between 0.05 and 5 mol and the doping concentration of copper is between 0.05 and 5 mol.

34. The light emitting phosphor material of claim 29 wherein said material is a thin film which has been annealed at between 550-850° C.

35. The light emitting phosphor of claim 29 where-in said phosphor material emits red light, and whose emission spectrum has a peak wavelength between 530 and 700 nm.

36. An alternating current thin-film electroluminescent device comprising front and rear sets of electrodes sandwiching a pair of insulators, said pair of insulators sandwiching thin film electroluminescent phosphor material therebetween suitable to substantially prevent DC current from flowing therebetween, said phosphor material comprising a thin film layer having the formula M^{II}S:Eu,Cu, wherein M^{II} comprises strontium and calcium, S is sulphur, Eu is europium, Cu is copper.

37. The phosphor material of claim 36 wherein said light is primarily emitted in the red region of the spectrum.

38. The phosphor material of claim 36 wherein the doping concentration of copper is between 0.05 and 5 mol.

39. The phosphor material of claim 36 wherein the doping concentration of europium is between 0.05 and 5 mol.

40. The phosphor material of claim 36 wherein the doping concentration of europium is between 0.05 and 5 mol and the doping concentration of copper is between 0.05 and 5 mol.

41. The light emitting phosphor material of claim 36 wherein said material is a thin film which has been annealed at between 550-850° C.

42. The light emitting phosphor of claim 36 wherein said phosphor material emits red light, and whose emission spectrum has a peak wavelength between 530 and 800 nm.

43. A light emitting phosphor material for an alternating current thin-film electroluminescent device that includes said phosphor material sandwiched between a pair of dielectric layers suitable to substantially prevent DC current from flowing therebetween, wherein said phosphor material is comprised of the formula M^{II}S:Eu,xx, wherein M^{II} is at least one of strontium and calcium, S is sulphur, Eu is europium, and xx is a co-dopant that results in an insignificant change in the emission spectra of M^{II}S:Eu, wherein M^{II} is said at least one of strontium and calcium, S is said sulphur, Eu is said europium, while also providing a significant energy transfer from xx centers to Eu centers.

44. The phosphor material of claim 43 wherein said light is primarily emitted in the red region of the spectrum.

45. The phosphor material of claim 43 wherein the doping concentration of xx is between 0.05 and 5 mol.

46. The phosphor material of claim 43 wherein the doping concentration of europium is between 0.05 and 5 mol.

47. The phosphor material of claim 43 wherein the doping concentration of europium is between 0.05 and 5 mol and the doping concentration of xx is between 0.05 and 5 mol.

48. The light emitting phosphor material of claim 43 wherein said material is a thin film which has been annealed at between 550-850° C.

49. The light emitting phosphor of claim 43 wherein said phosphor material emits red light, and whose emission spectrum has a peak wavelength between 530 and 700 nm.

50. An alternating current thin-film electroluminescent device comprising front and rear sets of electrodes sandwiching a pair of insulators, said pair of insulators sandwiching thin film electroluminescent phosphor material therebetween suitable to substantially prevent DC current from flowing therebetween, said phosphor material comprising a thin film layer having the formula M^{II}S:Eu,xx, wherein M^{II} is at least one of strontium and calcium, S is sulphur, Eu is europium, and xx is a co-dopant that results in an insignificant change in the emission spectra of M^{II}S:Eu, wherein M^{II} is said at least one of strontium and calcium, S is said sulphur, Eu is said europium, while also providing a significant energy transfer from xx centers to Eu centers.

51. The phosphor material of claim 50 wherein said light is primarily emitted in the red region of the spectrum.

52. The phosphor material of claim 50 wherein the doping concentration of copper is between 0.05 and 5 mol.

53. The phosphor material of claim 50 wherein the doping concentration of europium is between 0.05 and 5 mol.

54. The phosphor material of claim 50 wherein the doping concentration of europium is between 0.05 and 5 mol and the doping. concentration of copper is between 0.05 and 5 mol.

55. The light emitting phosphor material of claim 50 wherein said material is a thin film which has been annealed at between 550-850° C.

56. The light emitting phosphor of claim 50 wherein said phosphor material emits red light, and whose emission spectrum has a peak wavelength between 530 and 800 nm.

57. A light emitting phosphor material for an alternating current thin-film electroluminescent device that includes said phosphor material sandwiched between a pair of dielectric layers suitable to substantially prevent DC current from flowing therebetween, wherein said phosphor material is comprised of the formula M_{II}S:Mn,Cu, wherein M^{II} is strontium, S is sulphur, Mn is manganese, Cu is copper.

58. The phosphor material of claim 57 wherein said light is primarily emitted in the green region of the spectrum.

59. The phosphor material of claim 57 wherein the doping concentration of copper is between 0.05 and 5 mol.

60. The phosphor material of claim 57 wherein the doping concentration of manganese is between 0.05 and 5 mol.

61. The phosphor material of claim 57 wherein the doping concentration of manganese is between 0.05 and 5 mol and the doping concentration of copper is between 0.05 and 5 mol.

62. The light emitting phosphor material of claim 57 wherein said material is a thin film which has been annealed at between 550-850° C.

63. The light emitting phosphor of claim 57 wherein said phosphor material emits red light, and whose emission spectrum has a peak wavelength between 400 and 650 nm.

64. An alternating current thin-film electroluminescent device comprising front and rear sets of electrodes sandwiching a pair of insulators, said pair of insulators sandwiching thin film electroluminescent phosphor material therebetween suitable to substantially prevent DC current from flowing therebetween, said phosphor material comprising a thin film layer having the formula M^{II}S:Mn,Cu, wherein M^{II} is strontium, S is sulphur, Mn is manganese, Cu is copper.

65. The phosphor material of claim 64 wherein said light is primarily emitted in the green region of the spectrum.

66. The phosphor material of claim 64 wherein the doping concentration of copper is between 0.05 and 5 mol.

67. The phosphor material of claim 64 wherein the doping concentration of manganese is between 0.05 and 5 mol.

68. The phosphor material of claim 64 wherein the doping concentration of manganese is between 0.05 and 5 mol and the doping concentration of copper is between 0.05 and 5 mol.

69. The light emitting phosphor material of claim 64 wherein said material is a thin film which has been annealed at between 550-850° C.

70. The light emitting phosphor of claim 64 wherein said phosphor material emits green light, and whose emission spectrum has a peak wavelength between 400 and 650 nm.

71. A light emitting phosphor material for an alternating current thin-film electroluminescent device that includes said phosphor material sandwiched between a pair of dielectric layers suitable to substantially prevent DC current from flowing therebetween, wherein said phosphor material is comprised of the formula M^{II}S:Mn,Cu, wherein M^{II} is calcium, S is sulphur, Mn is manganese, Cu is copper.

72. The phosphor material of claim 71 wherein said light is primarily emitted in the green region of the spectrum.

73. The phosphor material of claim 71 wherein the doping concentration of copper is between 0.05 and 5 mol.

74. The phosphor material of claim 71 wherein the doping concentration of manganese is between 0.05 and 5 mol.

75. The phosphor material of claim 71 wherein the doping concentration of manganese is between 0.05 and 5 mol and the doping concentration of copper is between 0.05 and 5 mol.

76. The light emitting phosphor material of claim 71 wherein said material is a thin film which has been annealed at between 550-850° C.

77. The light emitting phosphor of claim 71 wherein said phosphor material emits green light, and whose emission spectrum has a peak wavelength between 530 and 700 nm.

78. An alternating current thin-film electroluminescent device comprising front and rear sets of electrodes sandwiching a pair of insulators, said pair of insulators sandwiching thin film electroluminescent phosphor material therebetween suitable to substantially prevent DC current from flowing therebetween, said phosphor material comprising a thin film layer having the formula M^{II}S:Mn,Cu, wherein M^{II} is calcium, S is sulphur, Eu is manganese, Cu is copper.

79. The phosphor material of claim 77 wherein said light is primarily emitted in the green region of the spectrum.

80. The phosphor material of claim 77 wherein the doping concentration of copper is between 0.05 and 5 mol.

81. The phosphor material of claim 77 wherein the doping concentration of manganese is between 0.05 and 5 mol.

82. The phosphor material of claim 77 wherein the doping concentration of manganese is between 0.05 and 5 mol and the doping concentration of copper is between 0.05 and 5 mol.

83. The light emitting phosphor material of claim 77 wherein said material is a thin film which has been annealed at between 550-850° C.

84. The light emitting phosphor of claim 77 wherein said phosphor material emits green light, and whose emission spectrum has a peak wavelength between 400 and 650 nm.
